(19) United States
(12) Patent Application Publication
(10) Pub. No.: US 2005/0286166 A1
(43) Pub. Date: Dec. 29, 2005

(54) Method of Manufacturing Thrust Plate, Method of Manufacturing Shaft for Dynamic Pressure Bearing, Dynamic Pressure Bearing, Spindle Motor and Recording Disc Driving Apparatus

(75) Inventors: Hironori Ando, Kyoto (JP); Hiroshi Igou, Saitama (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: NIDEC CORPORATION, Kyoto (JP)

(21) Appl. No.: 10/710,194

(22) Filed: Jun. 24, 2004

(51) Int. Cl. G11B 17/02

(52) U.S. Cl. 360/99.08

(57) ABSTRACT

The invention provides a method of inexpensively manufacturing a thrust plate having a groove formed in an inner peripheral surface, in a structure in which a dynamic pressure bearing is structured by using a shaft in which a thrust plate is fitted to a shaft main body. A method of manufacturing the thrust plate includes an extended pipe forming step of forming a tubular extended pipe in which a center hole is formed, a drawing step of applying a drawing work to the extended pipe so as to obtain a drawn member and form a groove in an inner peripheral surface, and a cutting step of cutting off the drawn member in a radial direction so as to form a plurality of disc-shaped members.

### BACKGROUND OF INVENTION

1. Field of the Invention

The present invention relates to a method of manufacturing a thrust plate for structuring a shaft for a dynamic pressure bearing together with a shat main body in which an outer peripheral surface constitutes a part of a radial bearing portion. More particularly, the present invention relates to a method of manufacturing a thrust plate which is formed in an annular shape having a center hole to which a shaft main body is fitted, and in which thrust surfaces constituting a part of a thrust bearing portion is formed on both end surfaces.

2. Background Art

A driving apparatus for a recording disc such as a hard disc or the like has a spindle motor for rotatively driving the recording disc within the apparatus. The spindle motor is arranged concentrically arranged with the recording disc. The spindle motor is mainly constituted by a stationary member to which a stator having an armature coil is fixed, a rotating member to which a rotor magnet opposing to the stator is fixed, and a bearing mechanism which rotatably supports the rotating member to the stationary member.

A hydrodynamic pressure bearing is used as the bearing mechanism in order to achieve higher speeds and lower vibration (noise). The hydrodynamic pressure bearing is comprised of a lubricating fluid such as oil or the like that is disposed in a small gap between the shaft and the sleeve, a radial/thrust bearing portion that includes dynamic pressure generating grooves that are formed on opposite surfaces.

More specifically, a spindle motor for a hard disc drive which a dynamic pressure bearing is used has been disclosed in Japanese Published Patent Application No. 2000-134897 and will be described below. This spindle motor is comprised of a stationary member, a rotating member and a bearing mechanism that is provided therebetween.

The stationary member is comprised of a motor frame which is fixed to a base of the hard disc drive, a cylindrical boss portion which is integrally provided in the motor frame concentrically, and a sleeve which is fitted into and fixed to an inner peripheral surface of the cylindrical boss portion. A stator is fitted around the outer peripheral surface of the boss portion and fixed thereto.

The rotating member is comprised of a rotor hub, and a shaft which is integrally provided in the rotor hub. A recording disc is mounted on the rotor hub. Furthermore, an annular rotor magnet is mounted on an inner side of a lower portion of an outer peripheral wall of the rotor hub, and faces the stator in the radial direction. The shaft is disposed such that it is capable of rotating inside the sleeve, and herringbone shaped dynamic pressure generating grooves are formed on one or both of an outer peripheral surface of the shaft and an inner peripheral surface of the sleeve. The gap between both of these opposing surfaces is filled with a lubricating agent such as oil, thus forming a pair of vertically disposed radial dynamic pressure bearing portions. A thrust plate provided on the lower end of the shaft is housed in a lower end large-diameter section of the sleeve, and a thrust cover is fitted and fixed to the lower end opening portion of a boss portion on a motor frame so as to close the lower end large diameter section of the sleeve. A herringbone-shaped or spiral shaped dynamic pressure generating grooves are formed on one or both of an upper surface of the thrust plate and a thrust surface of the sleeve opposing thereto, and the lubricant is filled between the opposing surfaces, whereby an upper thrust dynamic pressure bearing portion is formed. A herringbone shaped or spiral shaped dynamic pressure generating grooves are formed on one or both of a bottom surface of the thrust plate and the thrust cover opposing thereto, and the lubricant is filled between the opposing surfaces, whereby a lower thrust dynamic pressure bearing portion is formed.

In the dynamic pressure bearing spindle motor constructed in this manner, when the coil of the stator is supplied with electricity, rotational torque is generated by the electromagnetic interaction between a rotating magnetic field of the stator and a multipolar magnetic field of the rotor magnet, thereby rotating a rotating member including the rotor hub, the shaft and a rotating load (a recording disc). During this rotation, the radial load of the rotating member is supported by the pair of upper and lower radial dynamic pressure bearing portions formed between the shaft and the sleeve, and a thrust load of the rotating member is supported by the pair of thrust dynamic pressure bearing portions formed between the thrust plate and the sleeve, and the thrust cover, respectively.

On the other hand, the air melts in the lubricant used for the hydraulic dynamic pressure bearing, and the air appears as bubbles in the case that an internal pressure of the lubricant comes to a negative pressure (a pressure equal to or less than an atmospheric pressure). The bubbles causes generation of a vibration and deterioration of a non-repeatable run-out (NRRO). Further, the bubbles are volumetrically expanded in accordance with a temperature rise, and generates a leak-out of the lubricant. There is a case that the generated dynamic pressure becomes unbalance in the thrust bearing portion due to a working error of the dynamic pressure generating groove and the bearing constituting member, and the negative pressure is generated within the lubricant held in the outer peripheral portion of the thrust plate. Accordingly, in order to prevent the negative pressure from being generated within the lubricant, there is employed a structure in which a hole is provided for communicating between the upper and lower surfaces of the thrust plate, thereby circulating the lubricant between two thrust dynamic pressure bearing portions, and compensating the unbalance of the dynamic pressure generated in the upper and lower thrust bearing portions. The communication hole is specifically constituted by a plurality of grooves which are formed in the inner peripheral surface of the thrust plate and extend in an axial direction.

As a working method of the communication hole, that is, a method of manufacturing the shaft, the following method is employed. The shaft and the thrust plate are separate components, and a plurality of vertical grooves extending in the axial direction are formed in the inner peripheral surface of the thrust plate. Subsequently, one end of the shaft is pressure inserted to the inner peripheral surface of the thrust plate. Accordingly, a plurality of communication holes communicating in the axial direction are secured between the outer peripheral surface of one end of the shaft and the inner peripheral surface of the end surface close to the shaft in the thrust plate.

A method of manufacturing the thrust plate generally employs a method of obtaining an inner peripheral surface of a blank member after press punching (shearing work).

However, in the case of forming the vertical groove for the communication hole in the inner peripheral surface of the thrust plate at a time of manufacturing the thrust plate in accordance with the press molding, there is generated a problem that a product cost becomes high due to an appreciation of a metal mold cost and a labor hour of a trial, because an inner diameter of the circle is not uniform (because the circle is not a simple circle).

### SUMMARY OF INVENTION

An object of the present invention is to inexpensively manufacture a thrust plate having a groove formed in an inner peripheral surface, in a structure in which a dynamic pressure bearing is structured by using a shaft in which a thrust plate is fitted to a shaft main body.

A thrust plate manufactured by a method of manufacturing a thrust plate in accordance with the present invention is a member in which an outer peripheral surface structures a dynamic pressure bearing shaft together with a shaft main body constituting a part of a radial bearing portion, is formed in a circular ring shape in which a center hole to which the shaft main body is fitted is formed, and has thrust surfaces constituting a part of a thrust bearing formed in both end surfaces. The method of manufacturing the thrust plate includes an extended pipe forming step of forming a tubular extended pipe in which a center hole is formed, a drawing step of applying a drawing work to the extended pipe so as to obtain a drawn member and form a groove extending in a longitudinal direction in an inner peripheral surface of the drawn member, and a cutting step of cutting off the drawn member in a radial direction so as to form a plurality of disc-shaped members.

In the method of manufacturing the thrust plate, as is different from the press molding, it is possible to inexpensively manufacture the thrust plate in which the groove is formed in the inner peripheral surface. The drawing step has a diameter shortening step of making inner and outer diameters of the extended pipe small, and an inner peripheral surface working step of forming the groove in an inner peripheral surface of the extended pipe in which the inner and outer diameters are formed small. Since the diameter reduction of the extended pipe and the work of the inner peripheral surface are continuously executed in the drawing step, the number of the steps is reduced, so that a manufacturing cost is low. In the case that a grinding step of grinding both the end surfaces of the disc-shaped member is further provided after the cutting step, an accuracy in both end surfaces (the thrust surface) of the thrust plate is improved with respect to the inner peripheral surface, and a perpendicularity of the thrust plate plane is improved with respect to an axis of the shaft main body.

Another object of the present invention is to provide a shaft for a dynamic pressure bearing which can achieve a perpendicularity between the center axis of the shaft main body and the plane of the thrust plate and can be manufactured inexpensively, by using the thrust plate obtained by the manufacturing method mentioned above.

The other object of the present invention is to provide a dynamic pressure bearing which can stably support a high speed rotation and can be manufactured inexpensively, by using the shaft for the dynamic pressure bearing obtained by the manufacturing method mentioned above.

The other object of the present invention is to provide an inexpensive spindle motor by using the dynamic pressure bearing mentioned above, and to provide an inexpensive disc driving apparatus to which the spindle motor is mounted.

### BRIEF DESCRIPTION OF DRAWINGS

Referring now to the attached drawings which form a part of this original disclosure:

FIG. 1 is a simplified longitudinal cross-section of a spindle motor using a dynamic pressure bearing in accordance with the present invention;

FIG. 2 is a cross sectional view showing a part of the dynamic pressure bearing portion in FIG. 1 in an enlarged manner;

FIG. 3 is a perspective view of an extended pipe obtained by an extended pipe forming step corresponding to a part of a method of manufacturing a thrust plate;

FIG. 4 is a cross sectional view of a drawing machine showing a drawing step corresponding to a part of the method of manufacturing the thrust plate;

FIG. 5 is a perspective view of a drawn pipe obtained by the drawing step;

FIG. 6 is a perspective view of a disc-shaped member obtained by cutting off the drawn member; and

FIG. 7 is a cross sectional view showing a skeleton structure of a general hard disc apparatus.

### DETAILED DESCRIPTION

### First Embodiment

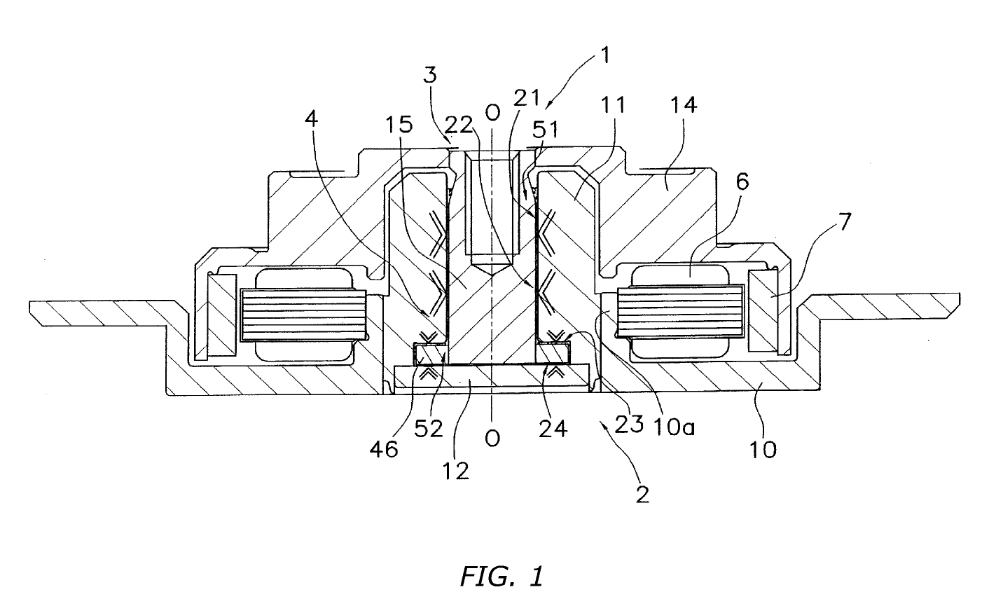

I. Entire Structure of Spindle Motor—FIG. 1 is a vertical cross sectional view schematically showing a simplified construction of a spindle motor 1 corresponding to an embodiment in accordance with the present invention. The spindle motor 1 is structured such as to rotate a recording disc such as a hard disc or the like, and structures a part of a recording disc driving apparatus.

In this case, a line O-O shown in FIG. 1 is a rotation axis of the spindle motor 1. Further, in the description of the present embodiment, a vertical direction in FIG. 1 is set to “axial vertical direction” as a matter of convenience, however, does not limit a direction of the spindle motor 1 in an actual mounted state.

In FIG. 1, the spindle motor 1 is primarily comprised of a stationary member 2, a rotating member 3 and a bearing mechanism 4 for supporting the rotating member 3 in the stationary member 2 such that the rotating member 3 is freely rotatable in the stationary member 2. The spindle motor 1 further includes a stator 6 comprising a stator core fixed to the stationary member 2 and a coil wound around the stator core, and a magnet 7 fixed to the rotating member 3. A magnetic circuit portion for applying a rotating force to the rotating member 3 is structured by the stator 6 and the rotor magnet 7.

II. Stationary Member—The stationary member 2 is comprised of a bracket 10, and a sleeve 11 that is fixed within a center opening of the bracket 10. In more detail, a cylindrical portion 10a that extends upward in an axial direction is formed on a center opening edge of the bracket 10, and an outer peripheral surface of the sleeve 11 is fitted to an inner peripheral surface thereof. Further, the stator 6 is fixed to an outer peripheral surface of the cylindrical portion 10a.

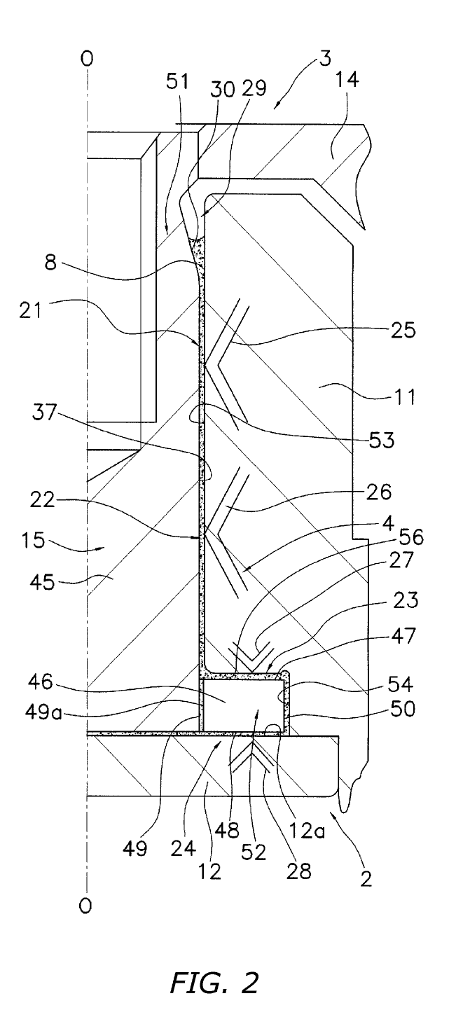

The sleeve 11 is a cylindrical member, and a through hole 51 that passes therethrough in an axial direction is formed approximately in a center portion thereof. As shown in FIG. 2, an inner peripheral surface of the through hole 51 in the sleeve 11 has a radial inner peripheral surface 53 and a lower inner peripheral surface 54 from an upper side toward a lower side. The lower inner peripheral surface 54 of the sleeve 11 forms a step portion 52 in a lower end of the through hole 51. The step portion 52 has the lower inner peripheral surface 54 having a larger diameter than that of the radial inner peripheral surface 53, and a thrust surface 56 directed to a lower side in an axial direction and connecting between the radial inner peripheral surface 53 and the lower inner peripheral surface 54.

A thrust cover 12 is fixed to a lower end of the through hole 51 of the sleeve 11, and the thrust cover 12 closes a lower end of the through hole 51. An outer peripheral side of an upper surface in an axial direction of the thrust cover 12 forms a thrust surface 12a that faces the thrust surface 56 of the sleeve 11 in the axial direction.

III. Rotating Member—The rotating member 3 is rotatably supported by the sleeve 11 so as to be freely rotatable therewith via a bearing mechanism 4, and is comprised of a rotor hub 14 in which a recording disc is mounted on an outer peripheral portion, and a shaft 15 which is positioned on an inner peripheral side of the rotor hub 14 and axially supported by the sleeve 11 via the bearing mechanism 4.

The rotor hub 14 is disposed above the stationary member 2 and the stator 6 in the vicinity thereof. A rotor magnet 7 is fixed to an inner peripheral surface of a cylindrical portion in the rotor hub 14 by means of an adhesion or the like. The rotor magnet 7 is opposed to the stator 6 at a small gap in the radial direction. By supplying electricity to the stator 6, a torque acts on the rotating member 3 through an electromagnetic interaction between the stator 6 and the magnet 7.

The shaft 15 is comprised of a columnar shaft main body 45, and a thrust plate 46 that is fit onto a lower end thereof. An upper end portion in an axial direction of the shaft main body 45 of the shaft 15 is fitted into a center hole in the rotor hub 14. Note that the shaft main body 45 may be press fit into the thrust plate 46 and the rotor hub 14, adhered thereto, or may be fitted using another method known to one of ordinary skill in the art.

The thrust plate 46 is an annular disc-shaped member which protrudes to an outer side in a radial direction from an outer peripheral surface in a lower end of the shaft main body 45, and has an inner peripheral surface 49 to which one end of the shaft main body 45 is press fit, an outer peripheral surface 50, an upper thrust surface 47 on the shaft main body side, and a lower thrust surface 48 opposite thereto. The upper thrust surface 47 of the thrust plate 46 faces the thrust surface 56 of the sleeve 11 with a small gap interposed therebetween, and the lower thrust surface 48 of the thrust plate 46 faces the thrust surface 12a of the thrust cover 12 with a small gap interposed therebetween.

IV. Bearing Mechanism—The bearing mechanism 4 is a hydrodynamic bearing which serves to support the rotating member 3 with respect to the stationary member 2. More specifically, the bearing mechanism 4 supports the rotor hub 14 and the shaft 15 with respect to the sleeve 11 via a lubricating oil 8 such that the rotor hub 14 and the shaft 15 are freely rotatable with respect thereto. The bearing mechanism 4 has first and second radial bearing portions 21 and 22, and first and second thrust bearing portions 23 and 24. A description will be given below of a structure of each of the bearing portions 21 to 24 while making reference to the structures of the sleeve 11, the thrust cover 12 and the shaft 15, with reference to FIG. 2.

1) Radial Bearing Portion—The radial inner peripheral surface 53 of the sleeve 11 faces an outer peripheral surface 37 of the shaft main body 45 of the shaft 15 so as to secure a small radial gap in which the lubricating oil 8 is held therebetween. A plurality of herringbone shaped dynamic pressure generating grooves 25 and 26 which are formed side by side in the axial direction and which serve to generate dynamic pressure in the lubricating oil 8 are formed in the radial inner peripheral surface 53 of the sleeve 11 in the peripheral direction. As mentioned above, the first and second radial bearing portions 21 and 22 are formed side by side in the axial direction, and are comprised of the radial inner peripheral surface 53 of the sleeve 11, the outer peripheral surface 37 of the shaft main body 45 of the shaft 15, and the lubricating oil 8 which resides therebetween.

2) Thrust Bearing Portion—A plurality of herringbone shaped dynamic pressure generating grooves 27 for generating the dynamic pressure in the lubricating oil 8 during the rotation of the shaft 15 are formed in the thrust surface 56 of the sleeve 11, and arranged in the peripheral direction. As mentioned above, the first thrust bearing portion 23 is formed by the thrust surface 56 of the sleeve 11, the upper thrust surface 47 of the thrust plate 46 and the lubricating oil 8 therebetween.

A plurality of herringbone shaped dynamic pressure generating grooves 28 for generating the dynamic pressure in the lubricating flow during the rotation of the shaft 15 are formed in the thrust surface 12a of the thrust cover 12 in a state of being arranged in a peripheral direction. As mentioned above, the second thrust bearing portion 24 is formed by the lower thrust surface 48 of the thrust plate 46, the thrust surface 12a of the thrust cover 12 and the lubricating oil 8 therebetween.

As mentioned above, a hollow cylindrical member relatively rotating with respect to the shaft 15 is comprised of the sleeve 11 and the thrust cover 12. In other words, the through hole 51 through which the shaft 15 extends is formed in the hollow cylindrical member, and the hollow cylindrical member has the radial inner peripheral surface 53 that faces the outer peripheral surface 37 of the shaft main body 45 with a small gap interposed therebetween, and the thrust surfaces 56 and 12a that faces the upper and lower thrust surfaces 47 and 48 of the thrust plate 46 with a small gap interposed therebetween.

Further, as shown in FIG. 2, a plurality of (three) vertical grooves 49a extending in an axial direction are formed in the inner peripheral surface 49 of the center hole in the thrust plate 46. The vertical groove 49a is open to both sides in the axial direction, and functions as an oil circulating portion communicating the first thrust bearing portion 23 with the second thrust bearing portion 24. Both sides in the axial direction of the thrust plate 46, that is, the first and second thrust bearing portions 23 and 24 are communicated even in their inner peripheral side portions by the vertical groove 49a, and the lubricating oil 8 tends to circulate between the first and second thrust bearing portions 23 and 24. Accordingly, the unbalance of the dynamic pressure is compensated between the first and second thrust bearing portions 23 and 24, and the negative pressure is hard to be generated within the lubricating oil held in the outer peripheral portion of the thrust plate 46. As a result, even in the case that the bearing mechanism 4 corresponding to a fulfill type dynamic pressure bearing is provided, and the herringbone shaped dynamic pressure generating grooves 27 and 28 are respectively formed in the first and second thrust bearing portions 23 and 24, as in the present embodiment, a problem caused by the bubble generation is hard to be generated.

A surface tension seal portion 29 is structured which prevents leakage of the lubricating oil 8 from the first radial bearing portion 21, and is formed in the outer end in the axial direction of the first radial bearing portion 21 by means of an inner peripheral surface of the sleeve 11 and an outer peripheral surface of the shaft 15. More specifically, a slope surface 30 is formed in a portion of the outer peripheral surface of the shaft 15 that is outside of the first radial bearing portion 21 in the axial direction such that it widens the gap between the outer peripheral surface of the shaft 15 and the inner peripheral surface of the sleeve 11 outward in the axial direction. The surface tension of the lubricating oil 8 held in the bearing portion and the outside air pressure are balanced, and a meniscus of the lubricating oil 8 is positioned at a point on the slope surface 30. As a result, if the lubricating oil 8 attempts to move further outward, the curvature of a liquid surface of the lubricating oil 8 try to grow larger, and thus this movement will be resisted and the movement of the lubricating oil 8 outside the bearing portion will be suppressed.

As described above, the bearing mechanism 4 is comprised of the first radial bearing portion 21, the second radial bearing portion 22, the first thrust bearing portion 23, and the second thrust bearing portion 24, and each of the bearing portions are continuously filled with lubricating oil. Furthermore, the lubricating oil 8 in each of the bearing portion is sealed by the surface tension seal portion 29 formed in the gap between the outer peripheral surface of the shaft 15 and the inner peripheral surface of the sleeve 11 in the upper portion thereof in the axial direction.

Note that while, in FIGS. 1 and 2, graphic symbols are used to illustrate each of the dynamic pressure generating grooves 25, 26, 27 and 28 for the sake of convenience, but that grooves are in fact formed in each of the surfaces 53, 53, 56 and 12a noted above.

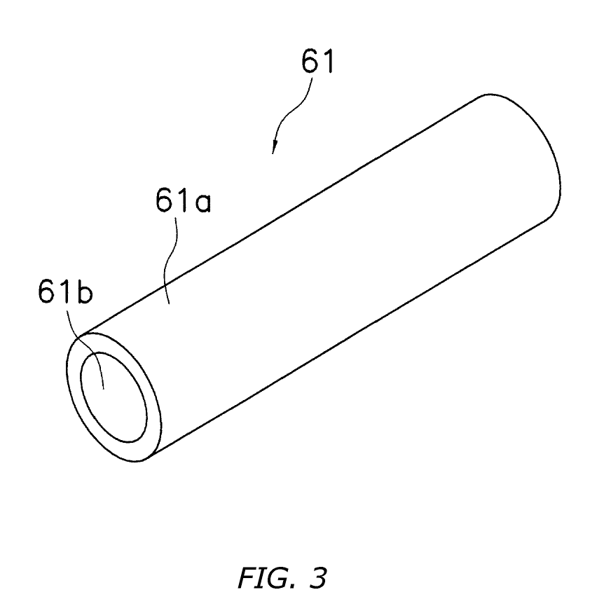

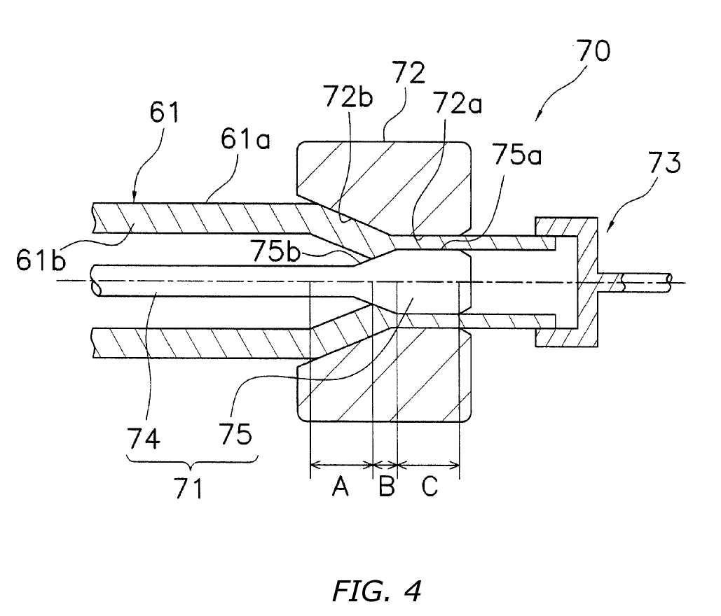

V. Method of Manufacturing Shaft—A description will be given below of a method of manufacturing the shaft 15, in particular, a method of manufacturing the thrust plate 46. The manufacturing method mainly has [1] extended pipe forming step→[2] drawing step→[3] cutting step→[4] end surface grinding step→[5] finishing barrel step.

[1]ExtendedPipe Forming Step—In a smelting furnace, materials such as a stainless steel, a copper alloy and the like are smelted, a circular rod-shaped steel billet having an outer diameter of 155 mm and a length of 200 to 500 mm is cast, the circular rod-shaped billet is formed as a pipe member having an inner diameter of 50 mm and an outer diameter of 60 mm in a hot extrusion step, and a tubular extended pipe 61 is formed by an extended pipe forming step including a heat treatment. As shown in FIG. 3, the extended pipe 61 has an outer peripheral surface 61a and an inner peripheral surface 61b which are formed in a complete round shape. In this case, inner and outer diameters of the extended pipe 61 are larger than inner and outer diameters of the thrust plate 46 corresponding to a final product.

[2]Drawing Step—Next, as shown in FIG. 4, the inner and outer peripheral surfaces of the extended pipe 61 are worked by using a drawing machine 70. In this case, in the following description, a lateral direction in FIG. 4 is called as a longitudinal direction, and in particular, a right side in FIG. 4 is called as a drawing side.

The drawing machine 70 is constituted by a cored bar 71, a die 72 and a chuck 73. The cored bar 71 and the die 72 are supported by a support table (not shown). The chuck 73 is connected to a drive mechanism constituted by a chain and a sprocket (not shown).

The cored bar 71 is a tool for working the inner peripheral surface 61b of the extended pipe 61, and is constituted by a center rod-shaped portion 74 and a working portion 75 formed in a drawing side leading end. An outer diameter of the center rod-shaped portion 74 is smaller than an inner diameter of the extended pipe 61. Accordingly, the extended pipe 61 can move in the longitudinal direction without being in contact around the center rod-shaped portion 74. The working portion 75 is formed in a leading end in the longitudinal direction of the center rod-shaped portion 74, and forms a portion for forming the groove in the inner peripheral surface 61b of the extended pipe 61. The working portion 75 is larger in an outer diameter than the center rod-shaped portion 74, and is provided with an outer peripheral surface 75a for working, and a taper surface 75b positioned in an opposite side to the drawing side. Three groove forming projections (not shown) extending in the longitudinal direction are formed in the outer peripheral surface 75a for working. An outer diameter of the taper surface 75b is increased toward the drawing side.

The die 72 is an annular member which is arranged in the drawing side of the working portion 75 slightly apart. The die 72 is a member for passing the extended pipe 61 through an inner portion thereof so as to work, and is provided with an inner peripheral surface 72a for working, and a taper surface 72b positioned in an opposite side to the drawing side, in an inner peripheral side thereof. An inner diameter of the inner peripheral surface 72a for working in the die 72 is smaller than an outer diameter of the extended pipe 61, and is slightly larger than an outer diameter of the working portion 75. Further, a maximum inner diameter in the taper surface 72b of the die 72 in a side in which the extended pipe 61 is fed is larger than the outer diameter of the extended pipe 61. Accordingly, when the extended pipe 61 passes through the inner side of the die 72, the extended pipe 61 is deformed such that both of the inner and outer diameters are shortened.

The chuck 73 is arranged further in the drawing side of the die 72. The chuck 73 holds the leading end of the extended pipe 61, and can move to the drawing side in the longitudinal direction under this state.

As shown in FIG. 4, the leading end of the extended pipe 61 is held by the chuck 73 through the inner side of the die 72. When the chuck 73 moves to the drawing side in this state, the extended pipe 61 is drawn and molded in accordance with the following steps.

Both of the outer diameter and the inner diameter of the extended pipe 61 are first miniaturized by the taper surface 72b of the die 72 (a narrowing zone A), and the inner diameter of the miniaturized extended pipe 61 is next enlarged by the taper surface 75b of the working portion 75 in the cored rod 71 while the outer diameter is continuously miniaturized by the taper surface 72b of the die 72, whereby the thickness is miniaturized by the die 72 and the cored rod 71 (a rolling zone B). The inner and outer diameters of the extended pipe 61 are positioned by the working inner peripheral surface 72a of the die 72 and the working outer peripheral surface 75a of the working portion 75, and a plurality of longitudinal grooves (not shown) are formed by the working outer peripheral surface 75a of the working portion 75, whereby a mirror formation of the inner and outer surfaces of the extended pipe 61 is simultaneously executed (a finishing zone C).

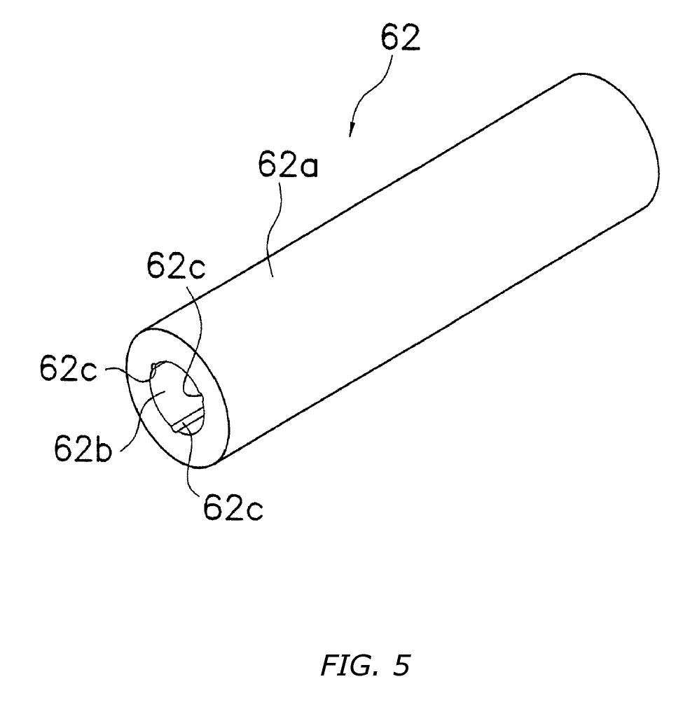

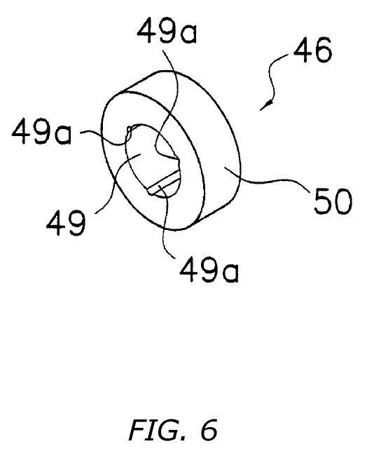

A drawing member 62 is formed in accordance with the above drawing steps, as shown in FIG. 5. The drawing member 62 is a tubular member, and has an outer peripheral surface 62a and an inner peripheral surface 62b. The outer peripheral surface 62a has a complete round shape. Three grooves 62c extending linearly in the longitudinal direction are formed in the inner peripheral surface 62b. In this case, the drawing member 62 is smaller than the extended pipe 61 in both of the inner and outer diameters.

[3] Cutting Step—Next, an NC lathe turning machine (an NC automatic machine) (not shown) is employed, the inner and outer peripheral surfaces of the drawing member 62 are turned by the NC automatic plate so as to finish the inner and outer diameters to a product dimensional level, and the drawing member 62 is sequentially cut along a radial direction, thereby forming a disc-shaped member corresponding to an original form of the thrust plate 46. The cutting work in this case is carried out by a thickness including a grinding margin. A high accuracy and a low cost can be achieved by simultaneously executing the inner and outer diameter finishing work and the cutting work of the drawing member 62 by means of the NC automatic machine.

[4]EndSurface GrindingStep—Next, an accuracy of a perpendicularity of the end surface with respect to the center hole is risen up by grinding both end surfaces of the disc-shaped member. In the case that the perpendicularity is within some μm, it is possible to obtain the dynamic pressure bearing having an improved rotational vibration accuracy.

[5]Finishing Barrel Step—Finally, a rounding work is applied to the disc-shaped member in accordance with the barrel (rounding) step, thereby removing burrs generated by the grinding work mentioned above. As a result, as shown in FIG. 6, there is obtained the thrust plate 46 in which the vertical grooves 49a are formed in the inner peripheral surface 49.

When fitting and fixing one end of the shaft main body 45 to the center hole of the thrust plate 46, that is, the inner peripheral surface 49 in accordance with a pressure insertion, an adhesion or the like, the shaft 15 is finished.

VI. Effect of Method of Manufacturing Thrust Plate—(a) In the method of manufacturing the thrust plate, it is possible to manufacture the thrust plate inexpensively as is different from the press molding. In the case that the thrust plate comes to inexpensive, the shaft, the dynamic pressure bearing, the spindle motor, the recording disc driving apparatus and the like employing the same also come to inexpensive. (b) In the manufacturing method, since the inner peripheral surface working and the diameter reduction of the extended pipe are continuously executed in the drawing step, the number of the steps is reduced, so that the manufacturing cost is reduced. (c) In the manufacturing method, since the finishing work and the cutting step of the inner peripheral surface of the thrust plate are simultaneously executed, it is possible to achieve a high accuracy and a low cost. As a result, it is possible to improve a bearing performance of the dynamic pressure bearing using the shaft. In other words, an accuracy improvement of the inner peripheral surface of the thrust plate contributes to a high speed rotation of the dynamic pressure bearing. Further, an accuracy improvement of the inner peripheral surface of the thrust plate contributes to a high speed rotation of the spindle motor, and an improvement of information reading or writing speed in the recording disc driving apparatus.

VII. Structure of Hard Disc Apparatus—The description is given above of the embodiment of the spindle motor 1 for driving the recording disc in accordance with the present invention. A description will be further given of a hard disc apparatus serving as the recording disc driving apparatus provided with the spindle motor 1 in accordance with the present invention.

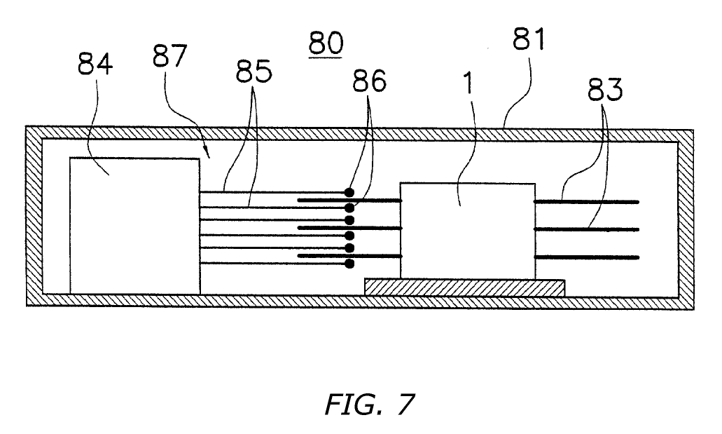

FIG. 7 is a schematic view showing an internal structure of a general hard disc apparatus 80. An inner portion of a housing 81 forms a clean space having an extremely small amount of dirt, dust or the like, and the spindle motor 1 to which a disc-shaped recording disc 83 recording the information is attached is placed in an inner portion of the housing. In addition, a magnetic head moving mechanism 87 reading and writing the information with respect to the recording disc 83 is arranged in the inner portion of the housing 81. The magnetic head moving mechanism 87 is constituted by a head 86 reading and writing the information on the recording disc, an arm 85 supporting the head, and an actuator portion 84 moving the head and the arm to a desired position on the disc.

In this hard disc apparatus 80, an improvement of information reading or writing speed is achieved by the high speed rotation of the spindle motor 1 mentioned above.

### Other Embodiments

The present invention is not limited to the embodiment mentioned above, but can be variously changed or modified within the scope of the present invention.

In specific, the present invention is not limited to the dynamic pressure bearing, the motor or the recording disc driving apparatus shown in the embodiment mentioned above. Further, in each of the bearing portions of the dynamic pressure bearing, with or without the dynamic pressure generating groove, the formed member or the shape of the dynamic pressure generating groove is not limited to the embodiment mentioned above.

Further, in the illustrated embodiment, the description is given by exemplifying the so-called axial rotating type spindle motor in which the shaft 15 is fixed to the rotor hub 14 and structures the rotating member 3, however, the present invention can be applied to a so-called axial fixed type spindle motor in which the shaft structures a part of the stationary member.

1. A method of manufacturing a thrust plate for a shaft in a dynamic pressure bearing, the shaft comprising a shaft main body in which an outer peripheral surface thereof comprises a part of a radial bearing portion, and a thrust plate comprising a central hole formed therein in which the shaft main body is fitted and thrust surfaces on both end surfaces thereof that comprise portions of thrust bearing portion, the method of manufacturing comprising:
an extended pipe forming step of forming a tubular extended pipe in which a center hole is formed;
a drawing step of applying a drawing work to said extended pipe so as to obtain a drawn member; and
a cutting step of cutting off the drawn member in a radial direction so as to form disc-shaped members.

2. The method of manufacturing a thrust plate according to claim 1, wherein said drawing step simultaneously form a groove extending in a longitudinal direction in an inner peripheral surface of said drawn member, in the process of obtaining the drawn member from said extended pipe.

3. The method of manufacturing a thrust plate according to claim 2, wherein said drawing step has a diameter shortening step of making inner and outer diameters of said extended pipe small, and an inner peripheral surface working step of forming said groove in an inner peripheral surface of said extended pipe in which the inner and outer diameters are formed small.

4. The method of manufacturing a thrust plate according to claim 1, wherein a grinding step of grinding both the end surfaces of said disc-shaped member is further provided after said cutting step.

5. A method of manufacturing a shaft for a dynamic pressure bearing, comprising:
the method of manufacturing a thrust plate according to claim 1; and
a fitting step of said shaft main body to the center hole of said thrust plate.

6. A dynamic pressure bearing comprising:
the shaft for the dynamic pressure bearing manufactured by the manufacturing method according to claim 5; and
a hollow cylindrical member having a through hole formed therethrough in which said shaft for the dynamic bearing passes, and which comprises a radial inner peripheral surface that faces an outer peripheral surface of said shaft main body with a small gap interposed therebetween, and thrust surfaces facing both end surfaces of said thrust plate with small gaps interposed therebetween;
wherein a radial bearing portion is structured by the outer peripheral surface of said shaft main body, the inner peripheral surface of said hollow cylindrical member, and the lubricating fluid disposed in the small gap, and wherein a thrust bearing portion is structured by both end surfaces of said thrust plate, the thrust surfaces of said hollow cylindrical member, and the lubricating fluid disposed in the small gap.

7. A spindle motor comprising:
the dynamic pressure bearing according to claim 6;
a stator that is non-rotatably disposed with respect to either said shaft of the dynamic pressure bearing or said hollow cylindrical member; and
a rotor magnet that is non-rotatably disposed with respect to either said shaft of the dynamic pressure bearing or said hollow cylindrical member, and which generates a rotating magnetic field in cooperation with said stator.

8. A recording disc driving apparatus comprising:
a housing;
the spindle motor according to claim 7 fixed inside said housing;
a disc shaped recording media non-rotatably disposed with respect to said shaft of the dynamic pressure bearing or said hollow cylindrical member and capable of recording data; and
data access means for writing data to or reading data from a desired location on said recording medium.
